(19) United States
(12) Patent Application Publication
(10) Pub. No.: US 2010/0250332 A1
(43) Pub. Date: Sep. 30, 2010

(54) System and Method for Adaptive Bidding for Display Advertising

(76) Inventors: Arpita Ghosh, Santa Clara, CA (US); Benjamin I.P. Rubinstein, Lafayette, CA (US); Sergei Vassilvitskii, New York, NY (US); Martin Zinkevich, Santa Clara, CA (US)

Correspondence Address: STATTLER - SUH PC, 60 SOUTH MARKET STREET, SUITE 480, SAN JOSE, CA, 95113, US

(21) Appl. No.: 12/414,166

(22) Filed: Mar. 30, 2009

(51) Int. Cl. G06Q 30/00; G06N 5/02

(52) U.S. Cl. 705/10; 705/26; 706/52; 705/14.48; 705/14.41

(57) ABSTRACT

A system for performing adaptive bidding to secure Internet advertising impressions in an auction. Included are systems for analyzing advertising campaign objectives, including a campaign period, a target number of impressions, a target budget. An exemplary technique defines a bidding agent for performing the adaptive bidding seeking the minimum target spending of the budget. Objective results of the campaign such as average cost per won impression, total campaign duration relative to desired campaign period, and total expenditure relative to campaign budget can be optimized based on an empirically determined forecast. Techniques for adapting bids include statistically modeling winning bids during an exploration bidding phase, performing iterations for adjustment of the bid amounts using learn-while-bid adaptive bidding, learn-then-bid adaptive bidding, and guess-double-adjust adaptive bidding. Bidding tactics, especially those used to identify a minimum target bid and a maximum target bid used in bidding on an exchange are employed, and the results analyzed using statistical models.

### FIELD OF THE INVENTION

The present invention is directed towards management of on-line advertising contracts based on adaptive bidding.

### BACKGROUND OF THE INVENTION

The marketing of products and services online over the Internet through advertisements is big business. Advertising over the Internet often seeks to reach individuals within a target group having very specific demographics (e.g. male, age 40-48, graduate of Stanford, living in California or New York, etc). This targeting of very specific demographics is in significant contrast to print and television advertisement that is generally capable only of reaching an audience within some broad, general demographics (e.g. living in the vicinity of Los Angeles, or living in the vicinity of New York City, etc.). The single appearance of an advertisement on a web page is known as an online advertisement impression. Each request of a web page by a user via the Internet represents an impression opportunity to display an advertisement in some portion of the web page to the individual Internet user. Often, there may be significant competition among advertisers for a particular impression opportunity for delivering an advertisement to an individual Internet user.

To participate in this competition, some advertisers enter auctions in order to win some desired number of impressions over a desired time period or to bid as often and as much as necessary so as to meet or optimize some objective (e.g. lowest average cost per impression) subject to some constraints (e.g. exhaust the budget by the end of the campaign period).

In traditional print or mass media advertising, such an optimization might be trivial. For example, to reach 2,000,000 impressions, an advertiser might advertise for some specific period (e.g. four weekly issues) in some popular periodical (e.g. the Midtown edition of the New Yorker Magazine). The price of the placements might be deemed fair (or even optimal) by the advertiser. In contrast to traditional print or mass media advertising, an Internet advertisement is able to specify detailed targeting criteria. For example, an advertiser may desire to spend $15,000 over the month of June for impressions made to males living in Midtown New York City who are over 30 years of age and have an interest in sports. This situation then precipitates an avalanche of questions: Does the advertiser guess at a fair price for the spots, and be satisfied with the first M impressions that exhaust the budget? Over what time frame would those M impressions occur? Will there be days when there are no impressions at all? Are some impressions that are priced above or below the advertiser's guess at a fair price actually more effective at achieving other of the advertiser's campaign objectives? If the guess were guessed at a higher price, would there be enough forecasted impression inventory of the higher-priced impression opportunities in order to exhaust the budget within the campaign period?

Even if the advertiser's guess were correct (i.e. equal to a winning bid on a spot market) at some moment in time, the guess might be wrong (i.e. too high) at another moment in time, resulting in possible over-spending. Or the guess might be too low, possibly resulting in failure to achieve the campaign objectives for a minimum number of impressions.

Especially when bidding might be done in a very narrow market (i.e. where the target specification is very narrow), an initial guess might be wildly wrong. Thus, what is needed is a system that automatically bids to learn a fair price for an impression opportunity, and then adapts bids over time in order to optimize an advertising campaign's objective.

Other automated features and advantages of the present invention will be apparent from the accompanying drawings and from the detailed description that follows below.

### SUMMARY OF THE INVENTION

A system for performing adaptive bidding to secure Internet advertising impressions in an auction. Included are systems for analyzing advertising campaign objectives, including a campaign period, a target number of impressions, a target budget. An exemplary technique defines a bidding agent for performing the adaptive bidding seeking the minimum target spending of the budget. Objective results of the campaign such as average cost per won impression, total campaign duration relative to desired campaign period, and total expenditure relative to campaign budget can be optimized based on an empirically determined forecast. Techniques for adapting bids include statistically modeling winning bids during an exploration bidding phase, performing iterations for adjustment of the bid amounts using learn-while-bid adaptive bidding, learn-then-bid adaptive bidding, and guess-double-adjust adaptive bidding. Bidding tactics, especially those used to identify a minimum target bid and a maximum target bid used in bidding on an exchange are employed, and the results analyzed using statistical models.

### BRIEF DESCRIPTION OF THE DRAWINGS

A brief description of the drawings follows:

FIG. 1A shows an advertising network environment in which some embodiments operate.

FIG. 1B shows an advertising network environment including an exchange auction server in which some embodiments operate.

FIG. 2 is a flowchart of operations within a system for adaptive bidding for display advertising, according to one embodiment.

FIG. 3 is a graph plotting spending performance of an embodiment of a system for adaptive bidding for display advertising against statistical expectations, according to one embodiment.

FIG. 4 is a graph plotting impression acquisition prediction performance of an embodiment of a system for adaptive bidding for display advertising against statistical expectations, according to one embodiment.

FIG. 5 is a flowchart showing a bidding tactic within a system for adaptive bidding for display advertising, according to one embodiment.

FIG. 6 is a flowchart showing a bidding adjustment tactic within a system for adaptive bidding for display advertising, according to one embodiment.

FIG. 7 is a flowchart showing an exploitation tactic within a system for adaptive bidding for display advertising, according to one embodiment.

FIG. 8 is a flowchart showing operations within a system for adaptive bidding for display advertising, according to one embodiment.

FIG. 9 is a flowchart showing operations within a bidding agent capable of adaptive bidding for display advertising, according to one embodiment.

FIG. 10 is a flowchart showing initialization operations within a bidding agent capable of adaptive bidding for display advertising, according to one embodiment.

FIG. 11 is a diagrammatic representation of a machine in the exemplary form of a computer system, within which a set of instructions for causing the machine to perform any one of the methodologies discussed herein may be executed, according to one embodiment.

FIG. 12 is a diagrammatic representation of several computer systems in the exemplary environment of a client server network, within which environment a communication protocol may be executed, according to one embodiment.

FIG. 13 is a flowchart showing bidding adjustment tactics within a system for adaptive bidding for display advertising, according to one embodiment.

FIG. 14 is a diagrammatic representation of several computer systems in the exemplary environment of a multi-server network, within which environment a communication protocol may be executed, according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

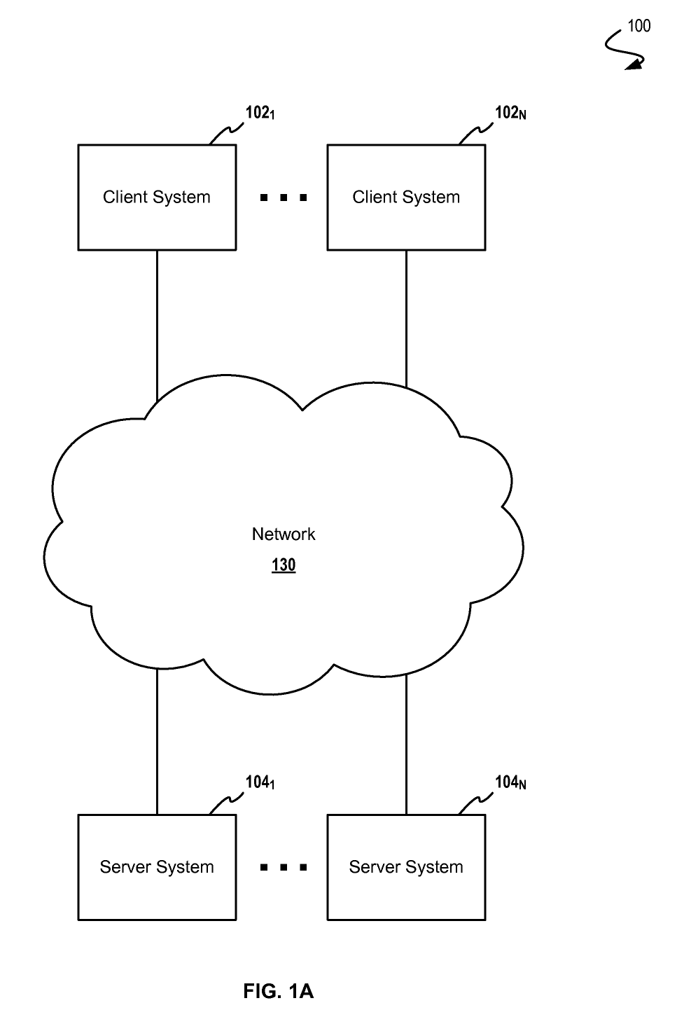

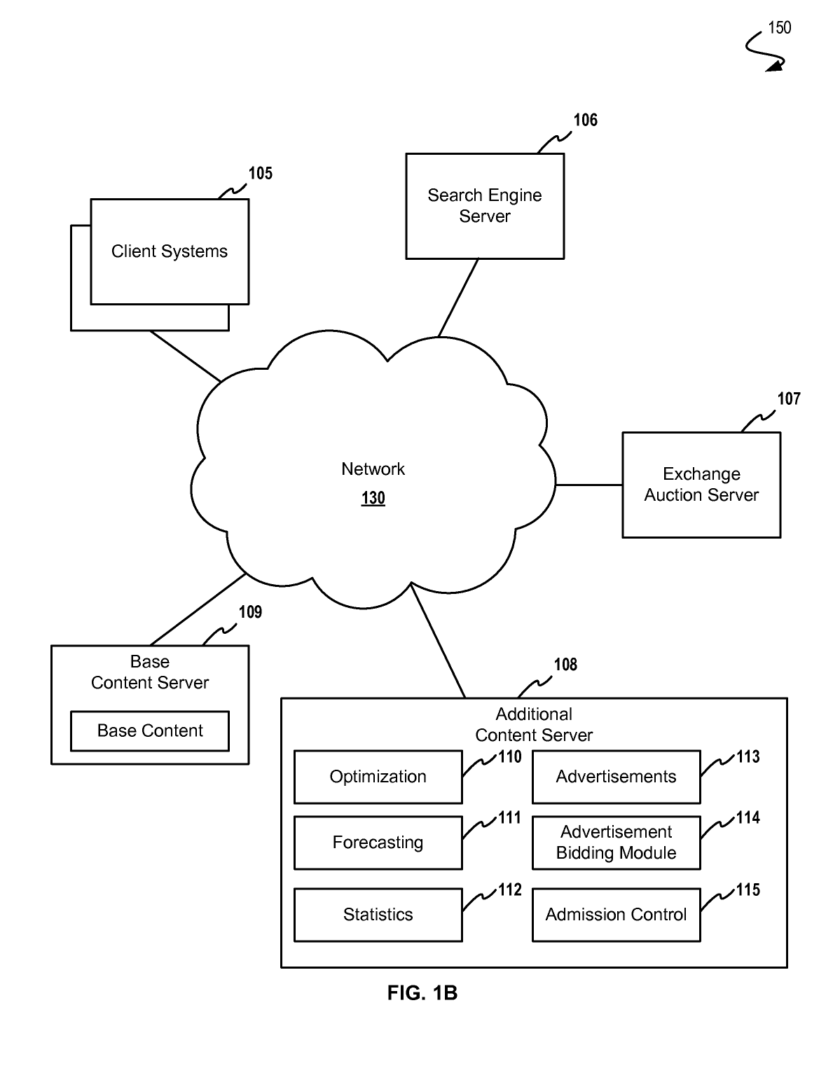

In the context of Internet advertising, bidding for placement of advertisements within an Internet environment (e.g. system 100 of FIG. 1A) has become common. By way of a simplified description, an Internet user, via a client system 102₁-102_{N} may visit a web page containing an advertisement served by a server 104₁-104_{N} for delivery to a client system 102 over a network 130.

In the slightly more sophisticated model of FIG. 1B, referring to system 150, and considering only Internet advertising, an Internet property (e.g. empirestate.com) hosted on a content server 109, might measure 10,000 hits in a given month. It also might be able to measure that of those 10,000 hits, 5000 of those hits originated from client systems 105 located in California. It might further be able to measure that of the 5,000 hits from California, 3300 of those were from individuals who identified themselves as male. Still further, the Internet property might be able to measure the number of visitors to empirestate.com who traversed to a sub-page, say empirestate.com/hotels, or the Internet property might be able to measure the number of visitors that arrived at the empirestate.com domain based on a referral from a search engine server 106. Still further, an Internet property might be able to measure the number of visitors that have any arbitrary characteristic, demographic or attribute, possibly using an additional content server 108, in conjunction with a data gathering or statistics operation 112 and a forecasting module 111. Thus an inventory of future impression opportunities can be known within some statistical certainty. Knowledge of some finite future supply combined with advertiser competition for that finite future supply has fostered the emergence of an auction-based marketplace for display ads, where advertisers can bid on individual display advertising opportunities in real time auctions, possibly employing an exchange auction server 107. Such a marketplace allows advertisers greater flexibility in the design and implementation of their display advertising campaigns that were previously restricted to contracts with publishers at pre-negotiated prices.

As earlier indicated, the supply of an impression opportunity that meets some target criteria, (e.g. males living in Midtown New York City who are over 30 years of age and have an interest in sports) might be known in the statistical sense, but the actual impression opportunity existence generally is not known until the Internet user actually requests a particular web page that could contain an advertisement. Only then can the demographic specifics of the target be known (e.g. the Internet user is a male living in Midtown New York City who is over 30 years of age and has an interest in sports), and thus the bidding can begin. Of course the Internet user is then waiting to receive the requested web page, so the auction begins and ends quickly—a latency of only a matter of fractions of a second are acceptable to most Internet users. Accordingly bidding agents (bots or other agent entities that prosecute an online advertising campaign) are employed to bid on behalf of the advertiser.

In addition to a target demographic description, a bidding agent might be provided with additional information that characterizes an advertising campaign (e.g. a period of time that the campaign should run, total budget, expected number of impressions, etc.). As well, the bidding agent might be provided with objective functions and constraints such as “minimize cost per impression while running the campaign through the end of the period.” Of course exchanges also may support bidding by other than a bot (e.g. by a natural person) although, for latency reasons, this is reasonable only for pricing blocks of advertisements or for pre-arranged or guaranteed delivery contracts. In temporally relaxed situations the bidding agent could either be an advertiser's employee on behalf of the advertiser, or an intermediary agent acting on behalf of the advertiser.

Now, following a typical bidding scenario, the bidding agent is tasked to acquire a given number of impressions with a given target budget (e.g. advertising spend), when the highest external bid in the marketplace is drawn from an unknown distribution P. The number of impressions/advertisements and spend are usually provided as givens within the campaign description due to the historical fact that display ads are usually sold on a cost per impression (CPM) basis. These given values might be used as constraints in the set-up of an optimization problem.

It should be noted that the act of bidding itself provides information used to adapt future bids. The act of bidding on a display advertising exchange at least partially answers the question, “What price are others willing to pay for an impression”. That is, before the first bid is won, the distribution of winning bids is unknown. However, repeated bidding, and recording and correlating those results yields information as to the market value of an impression of some particular characteristics. And knowing the distribution allows the system to calculate the minimum target spend to achieve the desired number of impressions. Similarly, a maximum target spend to achieve the desired number of impressions can also be known to a statistical certainty. Of course, although the advertiser may specify a target budget, the advertiser desires to achieve the other campaign objectives while spending the minimum amount of the budget. Embodiments of the invention herein seek to optimize (i.e. minimize the actual spend) while achieving other campaign objectives.

Now, in terms of defining and solving the aforementioned optimization problem, one must consider the optimization problem in at least two settings: (1) the transparent market where the winning price in each auction is announced, and (2) the partially observable market where only the winner obtains information about the winning bid. Repeating, the bidding agent is tasked to acquire a given number of impressions with a given target budget, when the highest external bid in the marketplace is drawn from an unknown distribution P. It should be axiomatic that if the distribution of winning bids were known or knowable a priori, then the optimization problem is a very simple optimization problem indeed. Still, if at least some statistical measurements could be taken in order to fairly gauge the distribution over time, then the optimization problem could be solved, at least within some statistical confidence level. Thus it is an aspect of the embodiments of the invention herein to take statistical measurements of the distribution of bids in both the case of a transparent market and the case of a partially observable market.

The methods employable in each of these two cases differ. In particular, the penalty incurred by the agent while attempting to learn the distribution is generally higher in a partially observable market than in a transparent market. The intuition around this is that in the partially observable case, a winning bid must be placed, (i.e. a portion of the budget actually spent) in order to collect observations of points in the distribution. Embodiments herein disclose techniques useful for both settings. Further, the performance of such techniques can be proven to fall within statistical bounds. Thus, an advertiser may have confidence that using the techniques herein to carry out adaptive bidding throughout an advertising campaign will achieve results that very nearly optimize at least one campaign objective under the constraints (e.g. achieve the lowest average cost per impression while achieving the target number of impressions, exhaust the budget while spending through the end of the campaign period, acquire as many impressions as possible within the campaign period, spend substantially all of the budget allocated within the campaign period).

Various systems, each implementing unique approaches corresponding to the transparent and partially observable markets are disclosed herein. Under simulation, the disclosed systems perform very well with respect to both target delivered impression quantity and achieving that within the campaign budget. Further, the systems for the partially observable case perform nearly as well as the systems for the fully observable case despite the higher penalty incurred during learning.

### Mathematical Description of the Problem

A cost per impression-based (CPM-based) campaign typically defines a target quantity of impressions that needs to be acquired over a certain time period with certain targeting characteristics. The targeting can include a wide variety of demographics, possibly including details about the Internet user, and possibly the Internet user's recent history, possibly even including information both about the web page on which the ad will appear, and even as well as the user's recently viewed web pages. In addition to the target impression quantity, a typical constraint in a CPM-based campaign is a budget constraint on the total spend. The problem statement includes the constraint that the bidding agent should exhaust (rather than simply stay within), the allocated budget. The intuition corresponding to this constraint is that advertisers prefer to exhaust their budgets allocated to a campaign. Having postulated this, one might recognize that not all impressions are regarded by advertisers as equally valuable, even though the target description might be identical. That is, the marketplace has built within it pieces of information (i.e. beyond merely the target demographic description) regarding how valuable a particular impression might be, and high bids for an impression might reflect this information; thus a high price in a marketplace might indicate high value. Accordingly some of the systems disclosed here assume that an agent implementing a campaign on behalf of an advertiser would also want to deliver high-value impressions subject to the chosen budget. Alternatively, in cases where the bidding tactics favor achievement of the number of impressions over achievement of average cost per impression when they are not simultaneously feasible, the agent can deliver the lower cost impressions if desired.

Consider a bidding agent that needs to win d impressions and has a total budget T. Assume that the bidding agent is at any point in time capable of retrieving a forecast of the total supply n of impressions that occur within the remaining campaign period and also satisfies the targeting requirements. While such a perfectly accurate forecast may not ever be available, a lower bound (e.g. a conservative forecast) of the supply can be used. Define f to be a fraction of the supply that the agent needs to win; thus, f=d/n. Define t=T/d to be target spend per impression won. Suppose that the highest bids from other bidders are drawn as independent and identically distributed (aka “i.i.d.”) from a distribution with a cumulative distribution function (CDF) P, and that each impression is sold using a second price auction. In general, a given target quantity and spend need not be simultaneously feasible for the distribution P. However, if it happens that a given target quantity and spend are simultaneously feasible, the agent can choose in favor of either the target quantity or in favor the target spend (depending on the favor preference as indicated by the advertiser's campaign description).

If the distribution P is known to the bidding agent, then the problem is simple to describe and simple to solve. Let z*=P⁻¹(t) be the bid that would win fraction f of the supply. Define p* such that E_{P}[X|X≦p*]=t, that is, p* is the bid that achieves the expected target spend t. If z*≦p* then bidding p* (with probability A=f/P(p*)) independently on each available impression achieves both of the expected supply and spend targets. Otherwise, favoring achievement of the fraction of the supply, a bid of z* achieves the expected desired fraction of supply.

In practice of bidding on impression opportunities, the existence of which specific opportunities are not known a priori except in the statistical, forecasting sense, the distribution P or estimation of the distribution P is also not known a priori to the bidding agent prior to the time the first bids are made. The problem is therefore one of learning (i.e. by bidding) the unknown distribution P in order to meet the target quantity and spend constraints. However, learning incurs a penalty, leading to an explore-exploit tradeoff. More specifically, a longer learning period would tend to result in a higher confidence level of the correct bidding strategy, however a longer learning period (the ‘explore’ period) during a campaign of finite duration implies a shorter time remaining in which to secure the desired number of forecasted impressions (the ‘exploitation’ period). And in fact a shorter exploitation period would tend to increase the fraction of the forecasted supply required to meet the campaign objectives as a later entry into the exploitation phase would imply there had been some impression opportunities counted in d that had occurred (during the learning phase), never to occur again, and thus effectively reducing the d available in the remainder of the campaign.

As regards any sort of learning or estimation of the distribution P by collecting observations, after collecting empirically observed samples to determine a distribution function, the “Dvoretzky-Kiefer-Wolfowitz inequality” (DKW inequality) might be used to aid in predicting how close the empirically determined distribution function will be to the distribution from which the empirical samples are drawn. In particular, the DKW inequality is used to bound the error in estimates as to the performance of the system. The nature and extent of the penalty depends in part on the assumptions made about the extent of information available to the bidding agent. Consider again the two marketplace settings:
Fully Observable Exchange. Here, the winning bid in each auction is announced in a manner such that all bidders can know the details of the winning bid. Thus the bidding agent can learn without placing any bids (or alternatively, by placing null bids) and therefore bidding and learning the distribution without expending any budget. The tradeoff here is between accuracy and length of exploration. A long exploration phase (thus shortening the remaining time in the campaign) could affect feasibility during exploitation.
Partially Observable Exchange. Here, the winning bid is not announced to all bidders-only the winner receives information about the winning price. This partially observable exchange is a realistic setting in the context of online advertising. Thus the bidding agent can infer information about P only by bidding high enough to win. The agent must pay (i.e. using the budget) for every observable sample in order to learn the distribution.

### Learn-then-Bid System/Learn-while-Bid System and Guess-Double-Adjust System

As an overview, below are disclosed possible tactics for agent bidding: The Learn-Then. Bid tactic, the Learn-While-Bid tactic and the Guess-Double-Adjust tactic.

The Learn-Then-Bid tactic is applicable to at least the above-described fully observable exchange. The disclosure models performance guarantees using non-asymptotic uniform convergence results for empirical processes. In simple terms, the Learn-Then-Bid tactic observes (without placing bids, since this is a fully observable exchange) and then bids according to the observed (empirical) distribution.

The Learn-While-Bid tactic is a natural improvement to the Learn-Then-Bid tactic in that Learn-While-Bid continues to learn during the exploitation phase.

The Guess-Double-Adjust tactic is especially useful in the partially observable case. As earlier indicated, the partially observable case is more constrained since a cost must be paid for every bid that is observed from the distribution. The Guess-Double-Adjust system explores the distribution gradually based on a “guess-then-double” pattern in order to control expenditure of budget during the learning phase. As will be shown, a simple guess-then-double algorithm (that is, absent the adjust techniques) can be improved upon since the distribution may have concentration right above a guess, which could lead to overspending. An adjust phase limits the overspending and also allows for performance guarantees.

It can be foreshadowed that both the Learn-Then-Bid tactic and its improved version Learn-While-Bid tactic, and also the Guess-Double-Adjust tactic, perform very well for a wide range of target fractions and spends in the applicable scenarios.

Of course, each of the tactics Learn-Then-Bid, Learn-While-Bid tactic, and also Guess-Double-Adjust perform some exploration. An exploration phase might be conducted over some time period not longer than the campaign period. And this time period might be divided into an exploration length m. An initial value for m might be calculated as a proportion of the total length of the campaign, or based upon a number of impressions desired to be won, for example the average time expected to secure 20% of d. Or an initial value for m might be retrieved from some saved value or values as a result of prior exploration runs. In a more sophisticated case, the initial value of m can be calculated as a function of the desired accuracy. That is, given a run with an accuracy goal of “90% Confidence”, an initial value for m might be twice the value for m for a run with an accuracy goal of “45% Confidence”.

### Agent Behavior Fully Observable Exchange

Consider a fully observable exchange where at least the amount of the winning bid is revealed to all bidders after every auction.
Learn-Then-Bid takes as inputs a target fraction f, a spend t, a supply n, and an exploration length m. The tactic explores for m steps by bidding null amounts and retrieving the amount of the winning bid (inasmuch as this is a fully-observable exchange). Thus, over the exploration length m, a system using Learn-Then-Bid forms the empirical CDF Pₘ from the observations Eᵢ˜P. It then computes bid value P*ₘ that would achieve the target spend t, and computes Z*ₘ that would achieve the necessary fraction. Moving to the exploitation phase, the system bids P*ₘ with probability Aₘ if it is feasible to achieve both targets on Pₘ, otherwise it bids Z*ₘ. Inasmuch as there exist tradeoffs between the explore phase and the exploit phase, some initial value for m might be selected at the beginning of the explore phase, and possibly revised during progression through the explore phase.

### Agent Behavior Partially Observable Exchange

Expend Budget to Obtain Samples for a Distribution: In the partially observable case, the winning bid information is revealed only to the winner of an auction. Thus the bidder must pay a cost (i.e. at least the cost in the amount of a winning bid) in order to obtain information regarding any specific winning bid, and moreover might pay a cost multiple times in order to gather the needed number of samples for use in estimating the distribution. In other words, a system operating under the rules of a partially-observable exchange cannot learn about the auction simply by bidding zero for a while.

Explore Aggressively: A possible theoretical approach is to submit bids of value b set to infinity or some arbitrarily large but finite amount (e.g. an amount greater than 100 times the calculated target average cost per impression) for an exploration period, and thus quickly gather samples (since the large bid is nearly guaranteed to win the auction). Although using the tactic of bidding arbitrarily large amounts such that every bid wins in auction indeed has the effect of returning samples for a distribution, using that tactic that can cause overspending by a factor of almost b/t when the target fraction is small. Instead, the techniques disclosed herein seek results at the end of the campaign that are approximately optimal.

Explore Blindly: Consider the following tactic: Bid 2t (i.e. an amount twice the calculated target average cost per impression) blindly until the correct number of impressions are obtained. Observe that since the minimum bid to get fn impressions is less than the bid that gets an expected price of t, then the expected price paid when a bid is made that obtains fn is less than or equal to t. Therefore, by Markov's inequality, the number of the lowest fn impressions below 2t is fn/2. Moreover, the most that can be spent is 2t*fn, and since the budget is t*fn, this is twice the budget. Therefore, this tactic will obtain only half the required impressions, though it will not dramatically overspend.

Guess-Then-Double Pattern: It is reasonable and possible to improve on the aforementioned bidding/learning tactics. Instead of following either of these extremes (i.e. bidding 2t blindly or aggressively exploring with b), the following discloses the guess-then-double pattern. The guess-then-double pattern is used in a variety of domains. For instance, in computer science, if one wants to create an array of items but how many elements it will contain is not at that moment known, the array can be sized via a ‘good’ a guess. If later, more space is needed, then the size of the array is doubled. Thus, the number of new allocations (i.e. the number of times the array is re-sized) is logarithmic in the number of elements entered, the increase in the number of elements is linear, and the size may be off (i.e. allocated but not actually used elements) by no more than a factor of two. Of course, doubling from the previous guess or amount as in the foregoing example is only one possibility. In the case of the array, multiplying by a factor smaller than 2 will result in an expense of more new allocation steps but with the benefit of greater efficiency in terms of allocated but unused space.

Guess-Double-Adjust Pattern: The Guess-Double-Adjust pattern applies a modification to the Guess-Then-Double pattern, which might then be used in the exploration phase. Define a bid being used during exploration as an exploration bid. A “safe” bid is t, the target cost per impression since it is unlikely to result in a significant overspending of the total budget. Thus the tactic begins the exploration phase with a ‘guess’ of t. Similar as in the Guess-Then-Double pattern, subsequent bids in the exploration phase are doubled from the previous bid, which increases exponentially beginning from the value of the initial exploration bid. Of course each winning bid is a sample that can then be used to learn something about the distribution (i.e. at least the portion of the distribution below the highest bid). At some point during this exploration phase (i.e. as the bid is successively doubled in each iteration), the exploration bid exceeds p*.

A naïve approach is to simply test for this condition at each iteration, and then react to our experience at the end of each phase of the exploration (i.e. remove lines 8-9). However, this can result in a large amount of overspending, as the following example shows. The target price is 10 cents and we need to obtain 10% of the 1000 impressions. Therefore, we are searching for 100 impressions for $10.00 total. The distribution of bids is: 9.9% are at 1 cent; 0.1% are at $9.01; the remaining 90% of the bids are at $10.00. An ideal bid is $9.01. However, it is difficult to say whether this one bid will be observed. Unless there is a very slow exploration, the bids will likely exceed $10.00 during exploration. Thus, there will be a high penalty where the algorithm will most likely pay 10 times its budget.

The system for adaptive bidding for display advertising recognizes when the exploration bid exceeds p*, and enters into a phase of “cautious exploration”. The intuition of entering and proceeding in this phase is as follows: If the guess-double-adjust bid would predictably result in overspending (i.e. the exploration bid is greater than p*), then momentarily ignore the budget constraint, and operate to achieve the desired number of impressions. As before, continue to increase the bid until it is statistically reliable that there are enough winnable impressions in the exploitation phase, then move into the exploitation phase. In other words, the exploration phase iterates (with or without bid adjustments) until it finds a price Bᵢ* where it estimates the total budget can be exhausted at the same time that it estimates it can win enough impressions (or it has explored at b or above). As with the observable case, this tactic yields a good approximation of the outcome of bidding any price below Bᵢ*, thus the exploration phase can conclude and enter the exploitation phase.

An intuitive description of the explore, adjust, and exploit phases is as follows: In the first phase, termed exploration, the agent explores until it either gets enough information about the distribution, or the budget becomes too tight. In the second (optional) phase, termed adjust, the agent adjusts in the case that the budget becomes too tight, but the bidding has not yet yielded enough information to model the distribution and thus predict if it is feasible to obtain the right number of impressions. This tactic aggressively bids for impressions until it does yield enough information to model the distribution and thus predict if it is feasible to obtain the right number of impressions. In the third phase, termed exploitation, if there is sufficient budget to obtain the desired number of impressions, then the agent tries to exhaust the budget. If there is not sufficient budget remaining to secure the desired number of impressions, the bidding agent tries to get the right number of impressions at a discount price.

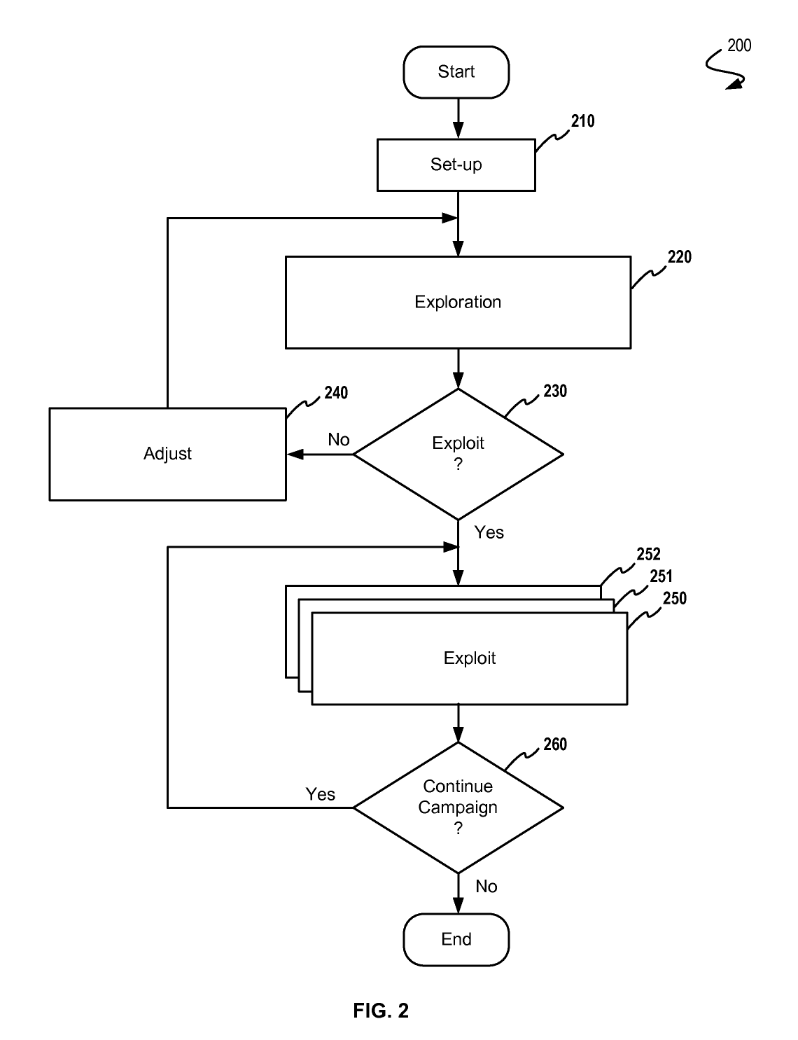

FIG. 2 is a flowchart of operations within a system for adaptive bidding for display advertising, according to one embodiment. As an option, the present system 200 may be implemented in the context of the architecture and functionality of FIG. 1A through FIG. 1B. In particular, system 200 might be included in environments 100 or 150. Of course, however, the system 200 or any operation therein may be carried out in any desired environment. As shown, a set-up operation 210 receives information about a campaign, possibly including specific constraints (e.g. campaign duration, desired total budget, etc), and proceeds to an exploration phase starting at operation 220. After one or more bids, the information regarding the distribution of winning bid prices might be sufficient to statistically model the distribution within some statistical confidence. Using this statistical criteria and/or other criteria, the decision 230 might be taken to either enter the exploitation phase (YES branch), or alternatively remain in the exploration phase (NO branch) after a possible adjustment at operation 240. When the exploitation phase has been entered, bids might be made based on any one or more exploitation tactics (see operations 250, 251, 252), until such time as a test and decision 260 determines that the budget has been exhausted, or for any other reason the campaign ends.

### Agent Behavior: Special Situations

Exploring Too Long Situation: It is theoretically possible to spend too much time in the exploration phase (i.e. a solution to the problem becomes infeasible). During the exploration phase, time passes, thus likely reducing the number of forecasted impression opportunities available during the remainder of the campaign. That is, the optimization problem may be insoluble if the exploration phase is too long. Note that in the Guess-Double-Adjust pattern, there will be no more than r=[log φ(b/t)]+1 rounds of exploration, because then the bid will be above b. In each round, there are m bids, so mr is the maximum number of rounds of exploration.

Underspending Situation: It is theoretically possible that the bidding agent underspends against the budget. For instance, suppose that the objective is to obtain a very small number of impressions at a very high price. For instance, suppose 10% of the impressions are at $11.00, 90% are at $1.00, the target spend is $2.00, and the agent wants 1% of the impressions. Therefore, bidding $11.00 is ideal. However, if the agent starts by bidding $2.00, it is possible that before the exploration phase is over, the agent obtains enough impressions, but has spent only half the budget.

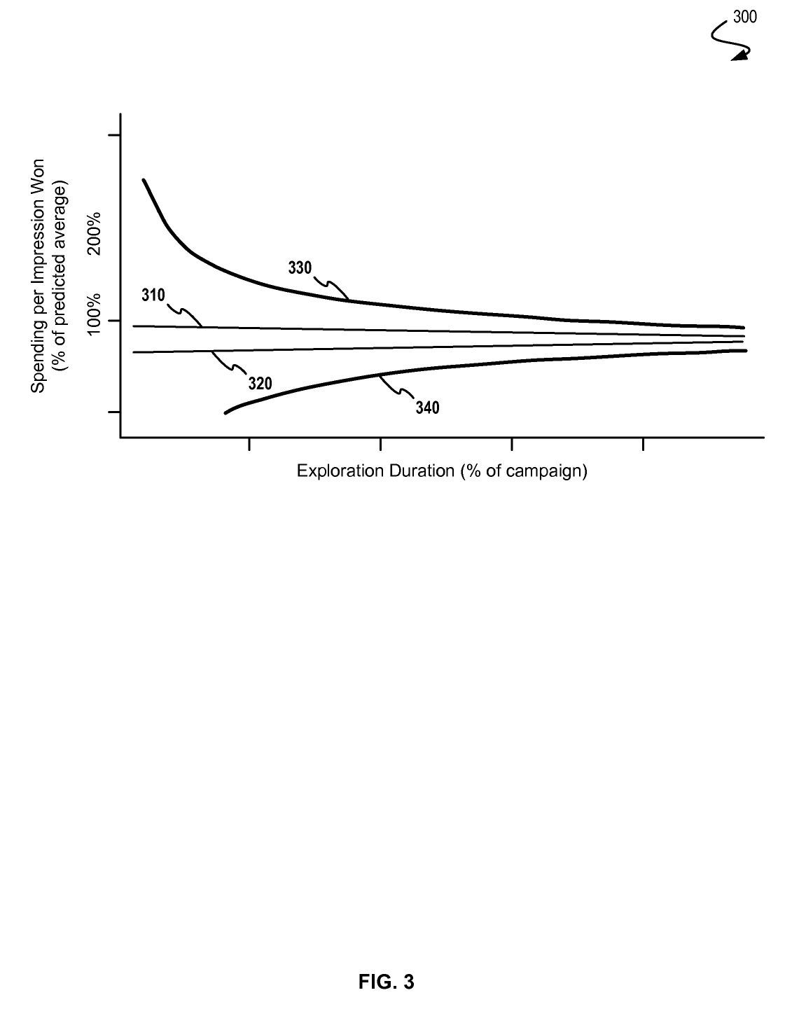

FIG. 3 is a graph plotting spending performance of a system for adaptive bidding for display advertising against statistical expectations, according to one embodiment. As an option, the present system 300 may be implemented in the context of the architecture and functionality of FIG. 1A through FIG. 2. As shown, the plot 300 compares the spending performance of a bidding agent during an exploration phase when applying the Learn-Then-Bid tactics. The curves 310 and 320 show upper and lower limits of spending per impression won, with respect to increasing exploration length. As exploration increases, the bounds become tighter but at the same time the problem becomes harder to satisfy until it becomes infeasible. The curves 310 and 320 fit the series of bid prices paid for winning an impression opportunity during exploitation, and are plotted against the 95% two-sided quantiles 330 and 340. As shown, the empirical results track the ideal within the 95% statistical confidence band.

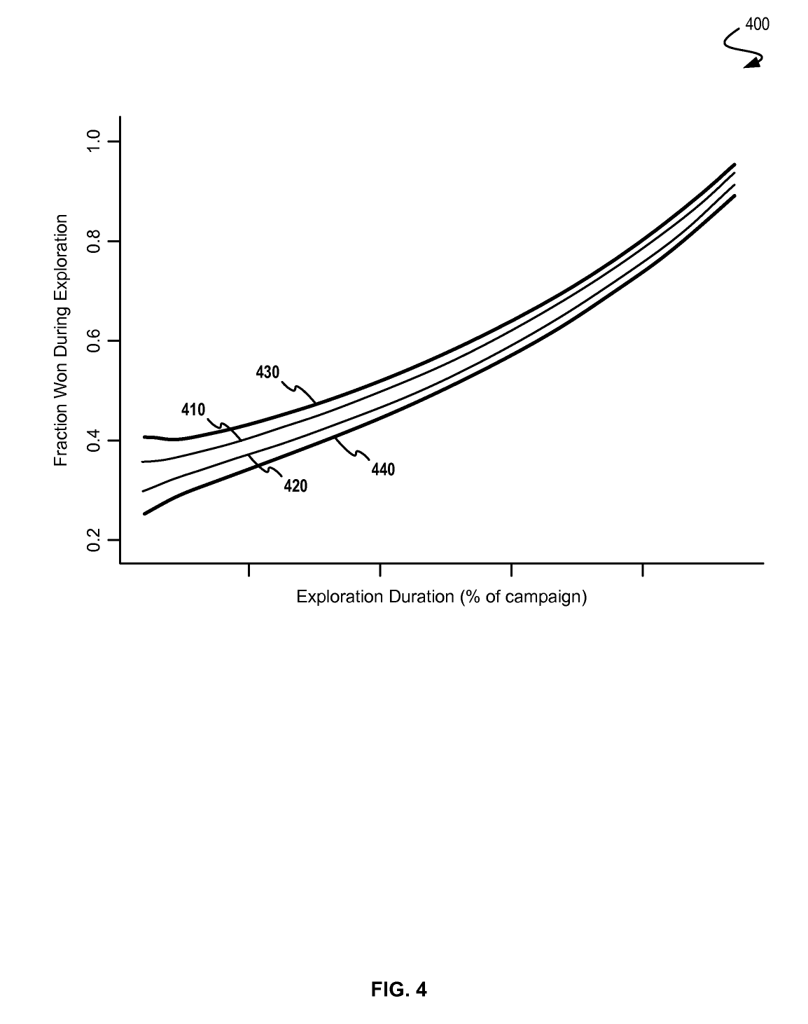

FIG. 4 is a graph plotting impression acquisition prediction performance of a system for adaptive bidding for display advertising against statistical expectation, according to one embodiment. As an option, the present system 400 may be implemented in the context of the architecture and functionality of FIG. 1A through FIG. 3. As shown, the plot 400 compares a bidding agent's prediction of future supply of impressions during an exploration phase when applying the Learn-Then-Bid tactic. The curves 410 and 420 show the upper and lower limits of the agent's prediction of future supply with respect to increasing exploration length. As exploration increases, the bounds become tighter but at the same time the problem becomes harder to satisfy until it becomes infeasible. The curves 410 and 420 fit the series of the agent's prediction of future supply of impression opportunities during exploitation, and are plotted against the 95% two-sided quantiles 430 and 440. As shown, the empirical results track the ideal within the 95% statistical confidence band.

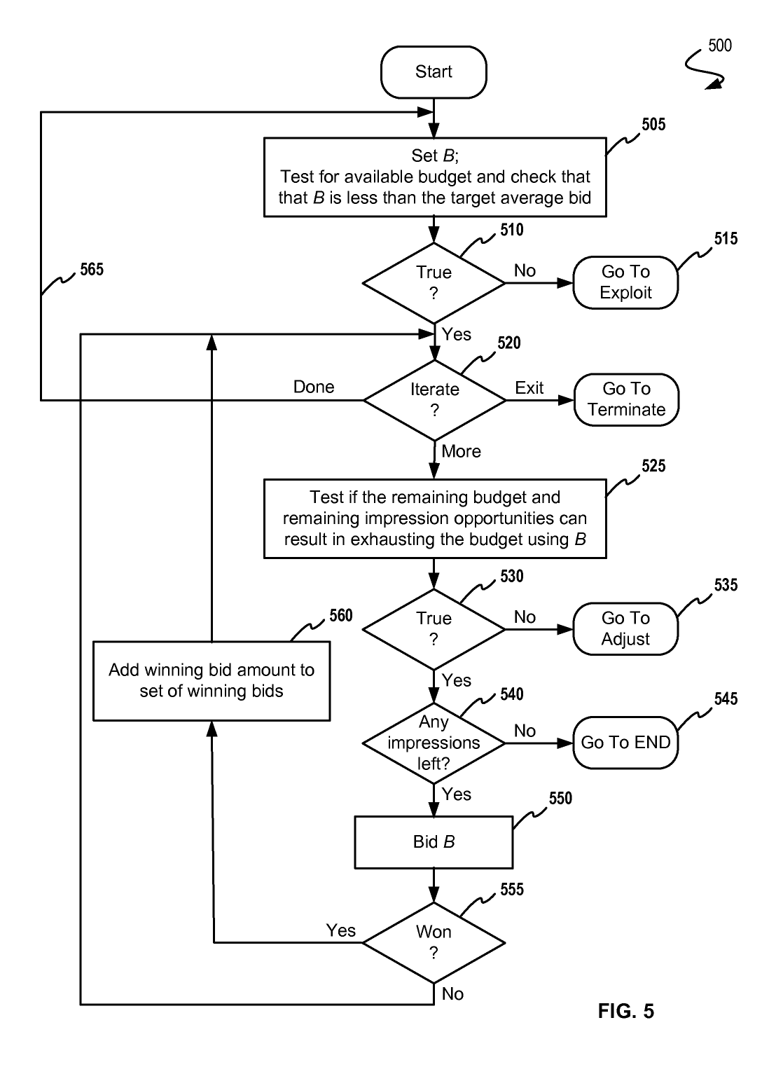

FIG. 5 is a flowchart showing a bidding tactic within a system for adaptive bidding for display advertising, according to one embodiment. As an option, the present system 500 may be implemented in the context of the architecture and functionality of FIG. 1A through FIG. 4. In particular, system 500 might be included in environments 100 or 150. Of course, however, the system 500 or any operation therein may be carried out in any desired environment. As shown, the bidding tactic for bidding during an exploration phase begins by entering a loop for bidding (B); the loop head 505 includes a test for if there remains sufficient budget to continue the exploration phase, and for if the next proposed bid is less than the target average bid. If so, the Yes branch of decision 510 is taken. Otherwise, the system proceeds to iterate a loop (see decision 520) within the exploitation phase. In the case that the Yes branch of decision 510 is taken, processing enters into an inner iteration loop, and some number of bids are actually bid over m (or fewer) iteration steps. During the iterations, it is possible that enough bids have been made to exhaust the budget. Such a case is possible when the number of target impressions is very small, and/or when the current bid amount is very large, or both. For each inner loop iteration, a test 525 is made to see if it is possible to exhaust the budget based on the remaining impression inventory available (and what the likelihood may be of winning at the current bid) as indicated in operation and test 525. If not, the bids need to be adjusted more rapidly and the system will proceed to the adjust phase (see operation 535). It is also possible during these iterations that there are simply no impressions remaining upon which to bid at any bid amount (see decision 540). In such a case the campaign is over (see operation 545) simply because there can be no more advertisements presented. Otherwise, since there remain impressions to be bid on, operation 550 places the bid. If the bid is a winning bid (see decision 555), then that data is added to the set with distribution observations (see operation 560). If not, in the next iteration (if any), the current bid is tried again.

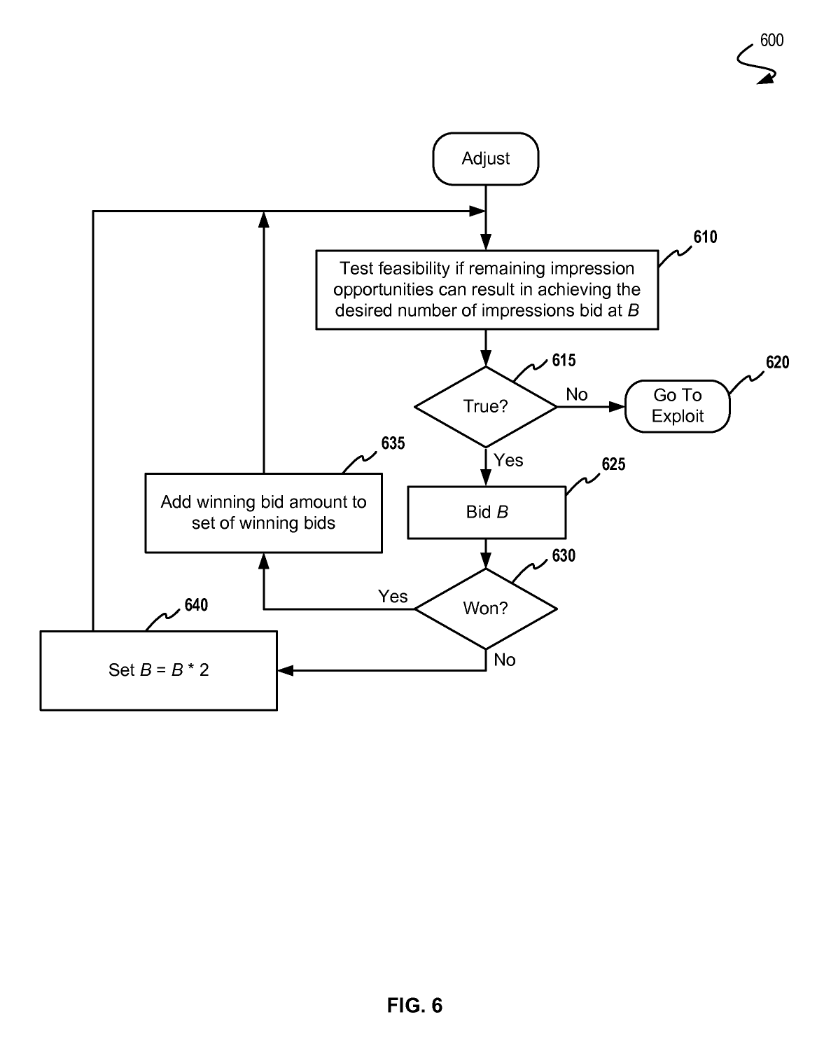

FIG. 6 is a flowchart showing a bidding adjustment tactic within a system for adaptive bidding for display advertising, according to one embodiment. As an option, the present system 600 may be implemented in the context of the architecture and functionality of FIG. 1A through FIG. 5. In particular, system 600 might be included in environments 100 or 150. Of course, however, the system 600 or any operation therein may be carried out in any desired environment. As shown, the bidding adjustment tactic for bidding during an exploration phase begins by entering a loop for aggressive bidding starting at test operation 610 to test if the current bid, if used in the exploitation phase, is feasible to achieve the desired number of remaining needed impressions for the campaign (see test operation 610 and decision 615). If so, then processing moves to the exploit phase (see operation 620); otherwise the current bid is either too low, or more observed samples need to be recorded in order to more accurately predict winnable impression opportunities. A bid B is placed (see operation 625). If the bid of operation 625 was the winning bid (see decision 630), then that observation is added to the set with distribution observations (see operation 635). If the bid B of operation 625 did not win, then this tactic aggressively increases the bid by a factor greater than 1 (as shown, by a factor of 2) in operation 640.

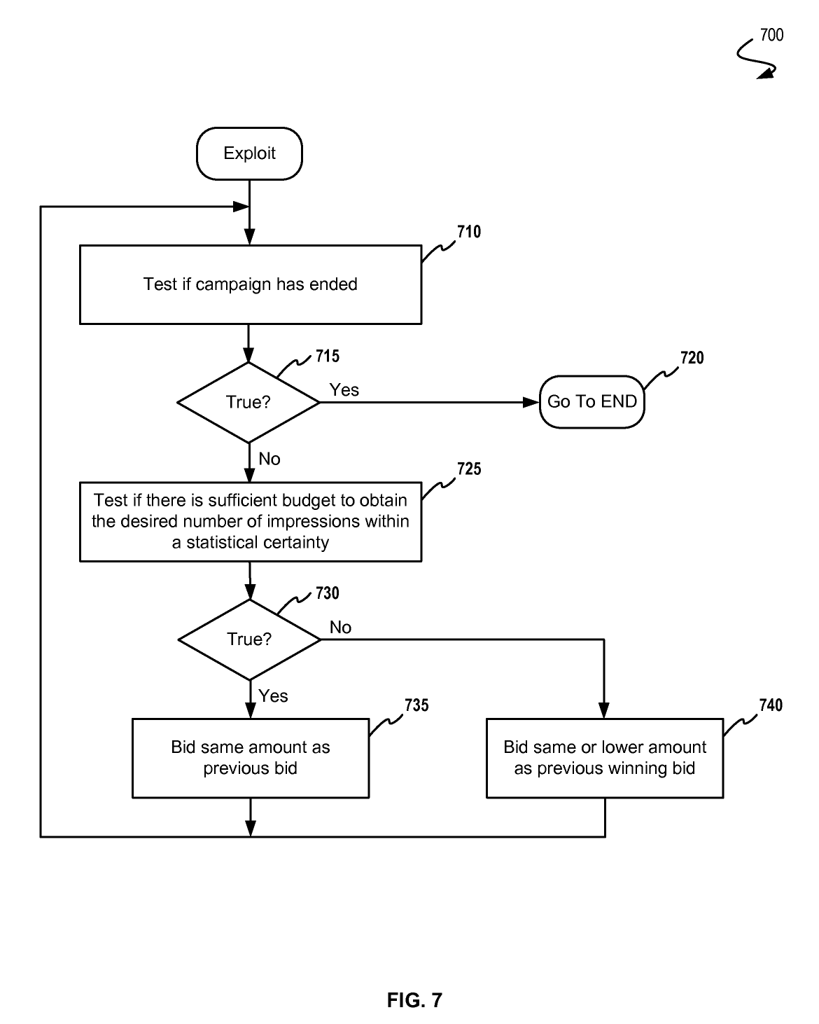

FIG. 7 is a flowchart showing an exploitation tactic within a system for adaptive bidding for display advertising, according to one embodiment. As an option, the present system 700 may be implemented in the context of the architecture and functionality of FIG. 1A through FIG. 6. In particular, system 700 might be included in environments 100 or 150. Of course, however, the system 700 or any operation therein may be carried out in any desired environment. As shown, the exploitation iterates through a loop wherein each iteration of the loop is operable for placing a bid. The iterations can end (see operation 720) when the campaign has ended for any reason, for example if there are no more matching impressions available, or if the desired number of impression opportunities have been won (see operation 710), of if the campaign period is over, etc. If the campaign has not ended (see decision 715), then bidding continues in the exploitation phase, first deciding what amount to bid based whether or not there remains sufficient budget to obtain the desired number of remaining impressions within a statistical certainty using the current bit amount (see operation and test 725). If so, (see decision 730) then the current bid amount is used (see operation 735). Otherwise a new current bid amount is recalculated and possibly adjusted (see operation 740) in order to increase the likelihood that the budget will be exhausted contemporaneously with reaching the desired number of impression opportunities won in the overall campaign.

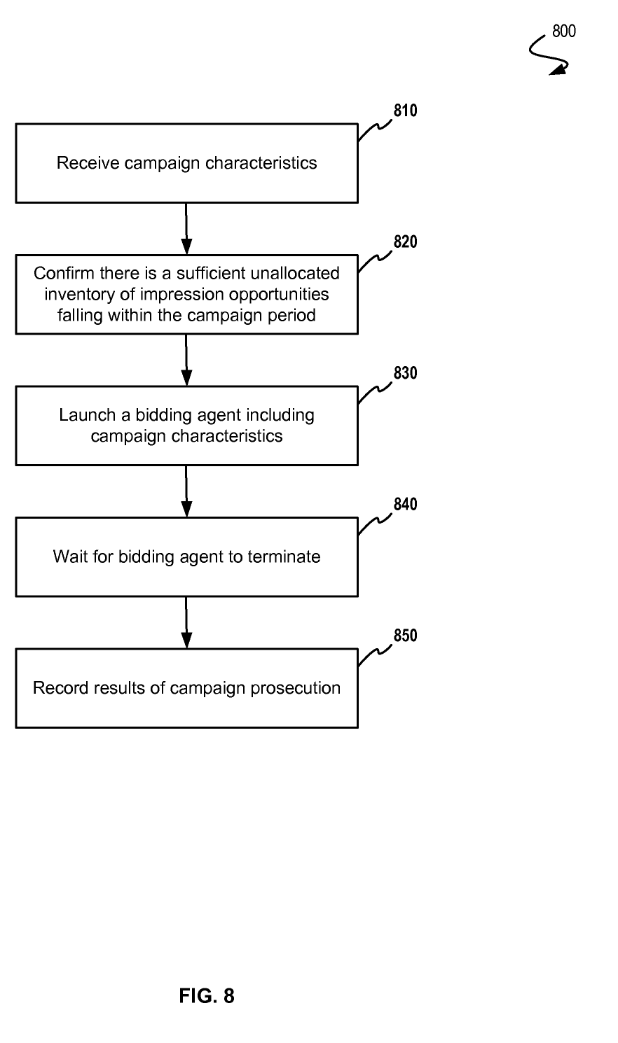

FIG. 8 is a flowchart showing operations within a system for adaptive bidding for display advertising, according to one embodiment. As an option, the present system 800 may be implemented in the context of the architecture and functionality of FIG. 1A through FIG. 7. In particular, system 800 might be included in environments 100 or 150. Of course, however, the system 800 or any operation therein may be carried out in any desired environment. As shown, the system comprises operations 810, 820, 830, 840, and 850 in order to implement adaptive bidding for display advertising within an advertising campaign. As earlier described, bidding agents (bots or other entities that prosecute an online advertising campaign) are employed to bid on behalf of the advertiser. An advertising campaign might include a target demographic description, a period that the campaign should run, a total budget, an expected number of impressions, etc., as well as an objective function “minimize cost per impression while running the campaign through the end of the period.” Accordingly, system 800, specifically operation 810 is operable to receive a range of campaign characteristics and confirm if there is a forecast (within some statistical certainty) for sufficient inventory available during the proposed campaign period (see operation 820). Assuming the campaign is not overly constrained (e.g. too short in time, too low in budget, too tight a target, etc) then system 800 executes operation 830 for launching a bidding agent. Inasmuch as a campaign might comprise a duration on the order of weeks or months, and inasmuch as a bidding agent may make bids at any point in time over the entire campaign period, it is a function of system 800 to wait (see operation 840) until the bidding agent terminates or otherwise signals that the bidding operations intended to be completed by the bidding agent have indeed been completed. At the conclusion of a campaign, any final results of the campaign are recorded (see operation 850).

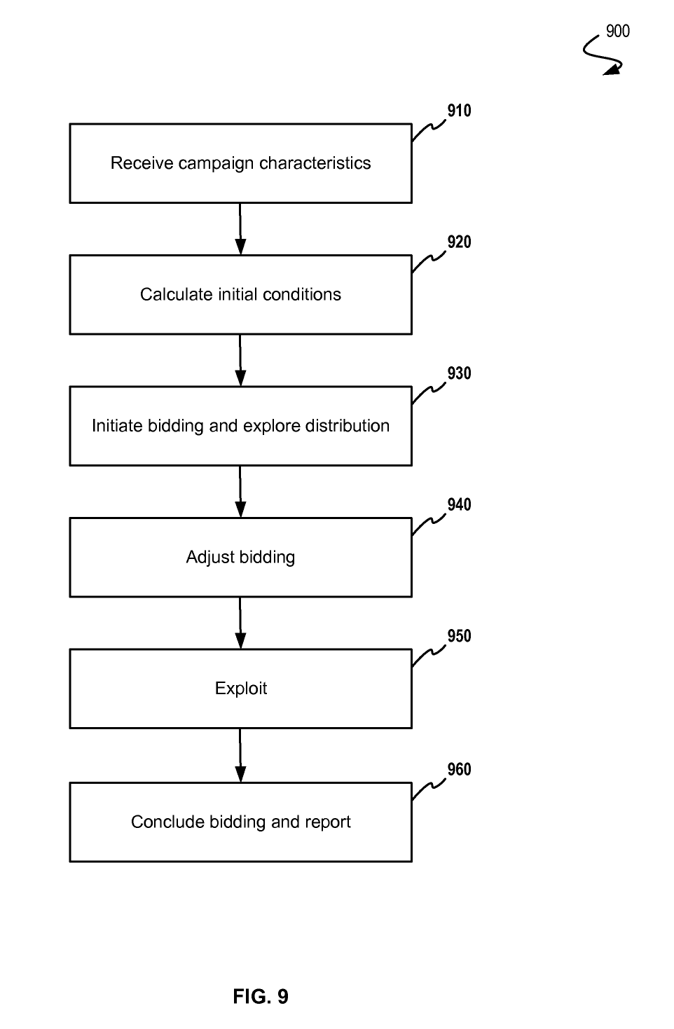

FIG. 9 is a flowchart showing operations within a bidding agent capable of adaptive bidding for display advertising, according to one embodiment. As an option, the present system 900 may be implemented in the context of the architecture and functionality of FIG. 1A through FIG. 8. In particular, system 900 might be included in environments 100 or 150. Of course, however, the system 900 or any operation therein may be carried out in any desired environment. As shown, the system comprises operation 910, 920, 930, 940, 950, and 960 in order to implement a bidding agent capable of adaptive bidding for display advertising within an advertising campaign. In particular, the agent is operable to receive a set of display advertising campaign characteristics (see operation 910) and from that set, possibly including other setup conditions or settings, a set of initial conditions might be calculated (see operation 920). Bidding is then initiated based on initial conditions (see operation 930) and, according to the bidding tactics disclosed hereinabove, the amounts, frequency, etc might be adjusted (see operation 940). Bidding continues until the campaign ends or until campaign objectives have been met or are deemed infeasible to meet (see operation 950). When the bidding agent has concluded the bidding activity, the bidding agent might then report any aspects of the campaign that had been recorded by the agent during the prosecution of the campaign (see operation 960).

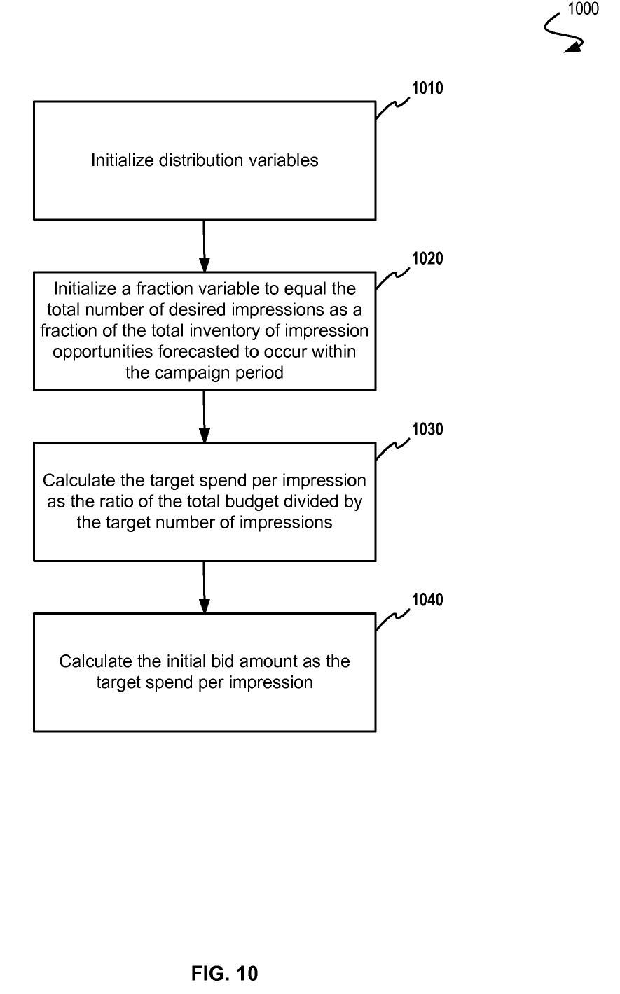

FIG. 10 is a flowchart showing initialization operations within a bidding agent capable of adaptive bidding for display advertising, according to one embodiment. As an option, the present system 1000 may be implemented in the context of the architecture and functionality of FIG. 1A through FIG. 9. In particular, system 1000 is operable to initialize variables pertinent to the initial setup and tests as may be performed by any bidding agent. The operations 1010, 1020, 1030, and 1040 are not intended to be an exhaustive depiction of all initialization operations, but merely a sample of initialization operations. Inasmuch as embodiments of the bidding agents disclosed herein might use statistical methods to determine likelihood of available inventory, likelihood of a bid at a particular price being the winning bid, etc., one or more distribution variables are defined and initialized (see operation 1010). Similarly the fraction variable is allocated and initialized (see operation 1020), the target spending per impression is calculated (see operation 1030), and an initial bid amount is calculated (see operation 1040).

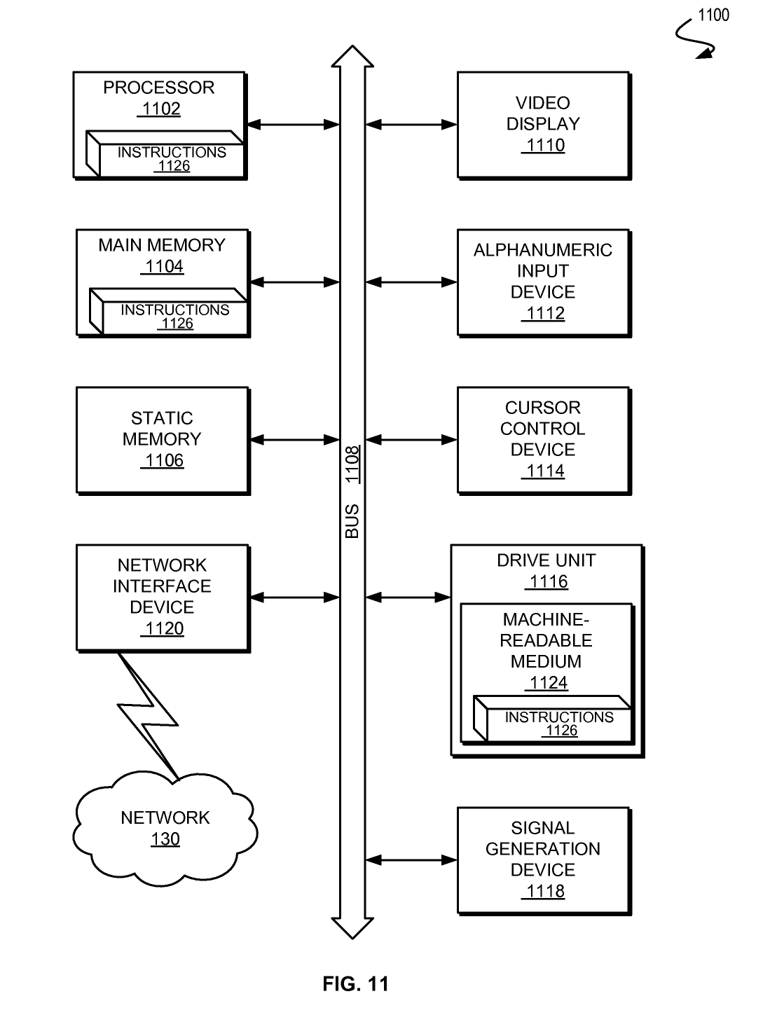

FIG. 11 is a diagrammatic representation of a machine in the exemplary form of a computer system 1100, within which a set of instructions for causing the machine to perform any one of the methodologies discussed above may be executed. The embodiment shown is purely exemplary, and might be implemented in the context of one or more of FIG. 1A through FIG. 10. In alternative embodiments, the machine may comprise a network router, a network switch, a network bridge, a Personal Digital Assistant (PDA), a cellular telephone, a web appliance or any machine capable of executing a sequence of instructions that specify actions to be taken by that machine.

The computer system 1100 includes a processor 1102, a main memory 1104 and a static memory 1106, which communicate with each other via a bus 1108. The computer system 1100 may further include a video display unit 1110 (e.g. a liquid crystal display (LCD) or a cathode ray tube (CRT)). The computer system 1100 also includes an alphanumeric input device 1112 (e.g. a keyboard), a cursor control device 1114 (e.g. a mouse), a disk drive unit 1116, a signal generation device 1118 (e.g. a speaker), and a network interface device 1120.

The disk drive unit 1116 includes a machine-readable medium 1124 on which is stored a set of instructions (i.e. software) 1126 embodying any one, or all, of the methodologies described above. The software 1126 is also shown to reside, completely or at least partially, within the main memory 1104 and/or within the processor 1102. The software 1126 may further be transmitted or received via the network interface device 1120 over the network 130.

It is to be understood that embodiments of this invention may be used as, or to support, software programs executed upon some form of processing core (such as the CPU of a computer) or otherwise implemented or realized upon or within a machine or computer readable medium. A machine readable medium includes any mechanism for storing or transmitting information in a form readable by a machine (e.g. a computer). For example, a machine readable medium includes read-only memory (ROM); random access memory (RAM); magnetic disk storage media; optical storage media; flash memory devices; electrical, optical, acoustical or other form of propagated signals (e.g. carrier waves, infrared signals, digital signals, etc.); or any other type of media suitable for storing or transmitting information.

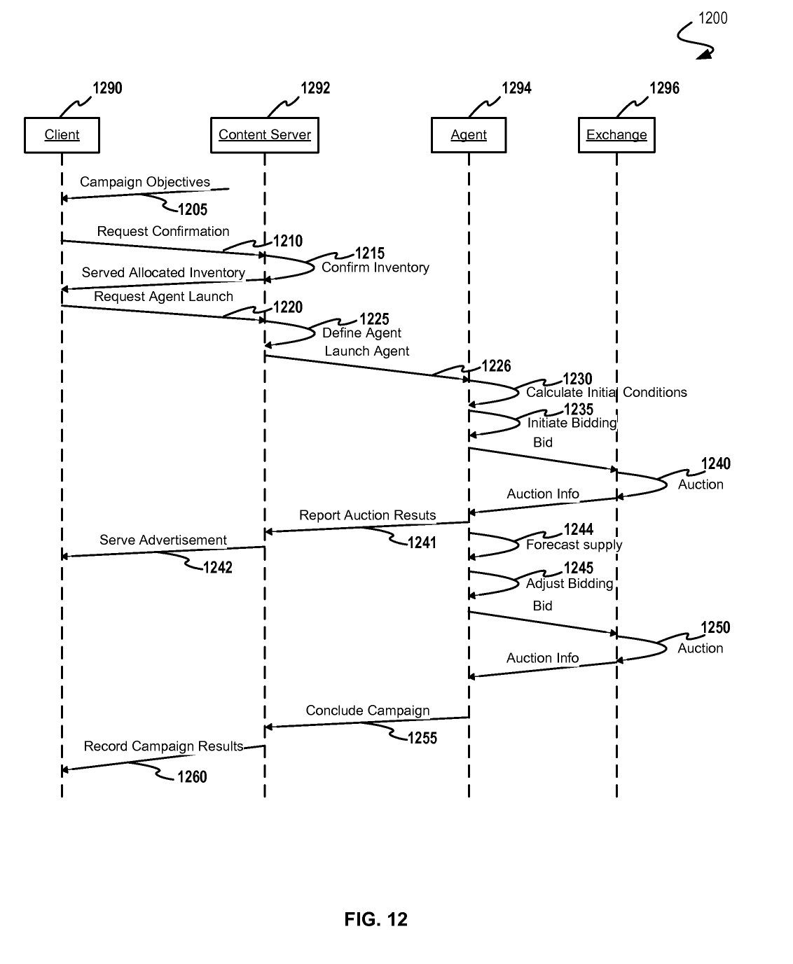

FIG. 12 is a diagrammatic representation of several computer systems (i.e. client, content server, auction/exchange server) or their constituent programs (e.g. browser, agent, API, etc) in the exemplary environment of a client server network 1200 within which environment a communication protocol may be executed, according to one embodiment. The embodiments shown are purely exemplary, and might be implemented in the context of one or more of FIG. 1A through FIG. 11. In one embodiment, the content server 1292 is operable for receiving a request message requesting confirmation that inventory for a display advertising campaign is likely to be available during the requested campaign period (see operations 1210 and 1215). The confirmation might be performed by an advertising server or content server 1292, and confirmation of inventory, possibly with an allocation status can be returned to the client requester 1290. In response to an affirmative confirmation and allocation, the client might then request a content server to launch an agent 1294 for bidding. Of course such an agent is operable to bid on behalf of the campaign, possibly using any of the bidding tactics disclosed herein. As shown, a content server defines the agent 1225 and launches the agent 1226. The agent then is operable to perform operations autonomously, possibly including calculation of initial conditions, 1230, initiating initial bidding 1235, capturing auction information (e.g. winning bid amount, number of bidders, second bid amount, other, etc) 1240, adjusting bid amounts 1245, and concluding bidding 1255. Of course the exchange 1296 might be implemented on one or more servers, in communication with other servers over network 130. As shown, the content server 1292 is operable to recognize when a campaign has concluded, and/or the bidding for that campaign has ended 1255, and the client 1290 might then receive and record campaign statistics 1260.

In another embodiment, again in the exemplary environment of a client server network 1200 the client 1290 is operable for receiving advertising campaign objectives 1205 (possibly including a campaign period, a target number of impressions, etc.); launching a bidding agent 1294 for performing adaptive bidding; reporting the winning bid 1241 to a content server 1292; and serving the advertisement 1242. Multiple iterations of the protocol steps 1240, 1241, 1242, 1244, 1245, and 1250 serve as steps for optimizing campaign results based on a statistical forecast of a number of impressions 1244.

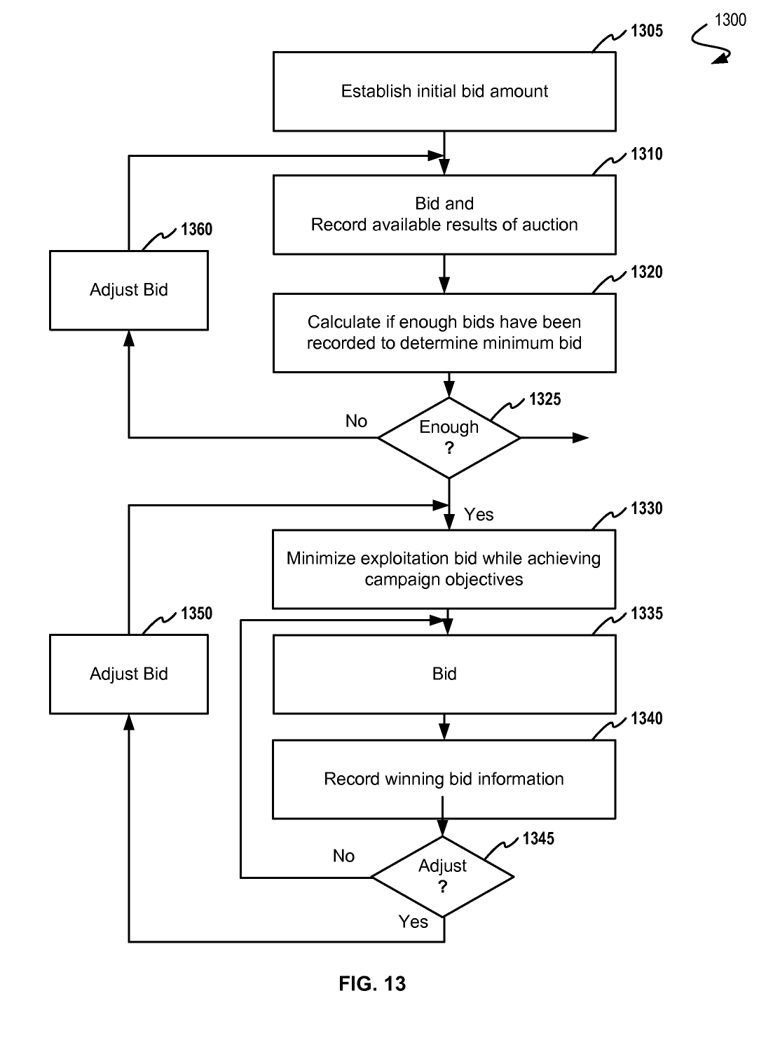

FIG. 13 is a flowchart exemplifying bidding adjustment tactics within a system for adaptive bidding for display advertising. As an option, the present system 1300 may be implemented in the context of the architecture and functionality of FIG. 1A through FIG. 12. System 1300 shows exploration bid adjustment operation 1360 and an exploitation bid adjustment 1350. The system for adaptive bidding 1300 uses a set of advertising campaign objectives, (e.g. a campaign period, a target number of impressions, a target budget, etc.) to establish an initial bid amount used in an exploration phase (see operation 1305). The system continues by performing exploration bidding and recording various available results of the auction (see operation 1310). As a series of bids are made and auction returns are recorded, a pattern or distribution of winning bids emerges from the recorded data, and such a pattern is examined iteratively (see operation 1320). As shown, a series of bids, together with returns from the auction are used to determine if the series of recorded results is sufficient for determining a minimum required bid and a maximum required bid for achieving campaign objectives (e.g. securing a desired number of impressions within the allotted budget, achieving the desired number of impression by the end of the campaign, etc). If, after calculating a likelihood of achieving at least one campaign objective one or more objectives can be reliably achieved (see decision 1325), then the system enters an exploitation phase and operation 1330 serves for performing exploitation bidding based on bidding an amount between the minimum required bid and the maximum required bid (see operation 1335). Of course, market sentiment and the amount of winning bids may change over time, so the minimum required bid and the maximum required bid may also change. Accordingly results from bidding are recorded (see operation 1340) and those results used in the determination if the bid amount should be adjusted (see decision 1345). Adjustment of the bid within the context of system 1300 (e.g. operation 1350 and operation 1360) may employ bidding/learning tactics such as learn-while-bid adaptive bidding, learn-then-bid adaptive bidding, guess-double-adjust adaptive bidding, and/or other tactics.

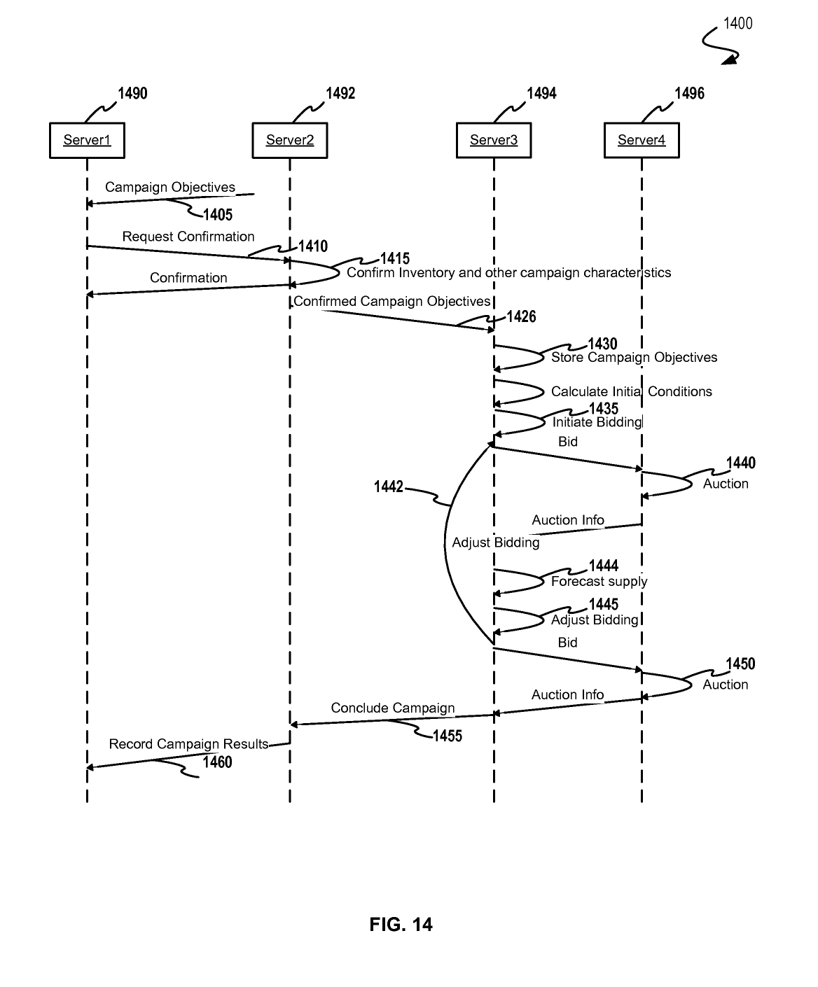

FIG. 14 is a diagrammatic representation of several computer servers (i.e. server 1490, server 1492, server 1494, and server 1496) in the exemplary form of a server network 1400 within which environment a communication protocol may be executed. The embodiment shown is purely exemplary, and might be implemented in the context of one or more of FIG. 1A through FIG. 13. The server network 1400 implements a communication protocol implementing adaptive bidding for display advertising in an online advertising campaign. The system 1400 is strictly exemplary and the assignment of operations to specific servers and the specific initiator and recipient of the messages is also strictly exemplary. As shown the protocol includes an operation for storing advertising campaign objectives, possibly including, a campaign period, a target number of impressions to be served during the campaign, and a target budget to be spent during the campaign (see operation 1430). The operations 1435, 1440, 1444 and 1445 serve for performing exploration bidding of ad offers for advertisement ad calls for determining a minimum required bid for winning an advertisement ad call auction and a maximum required bid for achieving at least one of the campaign objectives (also see operation 1442). In particular, operation 1444 serves for calculating a likelihood of achieving campaign objectives, and adjusting the minimum bid and maximum bid accordingly. For example, if the supply forecast is low relative to the remaining number of impressions to be served, then the minimum bid will be adjusted accordingly higher so as to increase the likelihood of winning the needed number of impressions as defined by the campaign. It is also possible that no bid adjustment is deemed necessary, and thus, bidding can proceed to auction 1450 for performing exploitation bidding for optimizing campaign results based on bidding a bid amount between the minimum required bid and the maximum required bid.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method for adaptive bidding for display advertising in an online advertising campaign comprising:
storing advertising campaign objectives, including at least one of, a campaign period, a target number of impressions to be served during the campaign, a target budget to be spent during the campaign;
performing exploration bidding of ad offers for advertisement ad calls for determining a minimum required bid for winning an advertisement ad call auction and a maximum required bid for achieving at least one campaign objective;
calculating a likelihood of achieving at least one campaign objective; and
performing exploitation bidding for optimizing campaign results based on bidding a bid amount between the minimum required bid and the maximum required bid.

2. The method of claim 1, wherein performing exploration bidding includes performing iterations for adjustment of the exploration bid amount using at least one of, learn-while-bid adaptive bidding, learn-then-bid adaptive bidding, guess-double-adjust adaptive bidding, an exploration bid amount calculation;

3. The method of claim 1, wherein performing exploration bidding phase includes retrieving a supply forecast.

4. The method of claim 1, wherein performing bidding phase includes calculating the campaign average cost per impression.

5. The method of claim 1, wherein performing exploration bidding phase includes bidding an amount greater than twice the calculated target average cost per impression.

6. The method of claim 1, wherein performing exploration bidding phase includes calculating the feasibility of winning the target number of impressions based on bids equal to average cost per impression.

7. The method of claim 1, wherein calculating a likelihood includes predicting how close an empirically determined distribution function will be to the distribution from which the empirical samples are drawn.

8. The method of claim 7, wherein calculating a likelihood includes calculating a Dvoretzky-Kiefer-Wolfowitz inequality.

9. The method of claim 1, wherein calculating a likelihood includes calculating an amount twice the calculated target average cost per impression.

10. The method of claim 1, wherein calculating a likelihood increases the exploration bid by a factor greater than 1.

11. The method of claim 1, wherein calculating a likelihood includes a test if continued use of the exploration bid amount is feasible to achieve the desired number of remaining needed impressions for the campaign.

12. The method of claim 1, wherein calculating a likelihood includes a test to determine if the current bid is too low.

13. The method of claim 1, wherein calculating a likelihood includes a test to determine if more observed samples need to be recorded in order to more accurately predict winnable impression opportunities.

14. The method of claim 1, wherein performing exploitation bidding includes a test if the campaign has ended.

15. The method of claim 1, wherein performing exploitation bidding includes a test if there are no more matching impressions available.

16. The method of claim 1, wherein performing exploitation bidding includes a test if the desired number of impression opportunities have been won.

17. The method of claim 1, wherein performing exploitation bidding includes a test if there remains sufficient budget to continue bidding.

18. The method of claim 1, wherein optimizing campaign objectives includes optimizing to achieve the lowest average cost per impression.

19. The method of claim 1, wherein optimizing campaign results includes optimizing to exhaust the budget by the end of the campaign period.

20. An apparatus for implementing a method for adaptive bidding for display advertising in an online advertising campaign comprising:
a module for storing advertising campaign objectives, including at least one of, a campaign period, a target number of impressions to be served during the campaign, a target budget to be spent during the campaign;
a module for performing exploration bidding of ad offers for advertisement ad calls for determining a minimum required bid for winning an advertisement ad call auction and a maximum required bid for achieving at least one campaign objective;
a module for calculating a likelihood of achieving at least one campaign objective; and
a module for performing exploitation bidding for optimizing campaign results based on bidding a bid amount between the minimum required bid and the maximum required bid.
